(19) United States
(12) Patent Application Publication
(10) Pub. No.: US 2009/0280883 A1
(43) Pub. Date: Nov. 12, 2009

(54) INTERACTIVE GAMING DEVICE

(76) Inventor: Brian D. Haveson, Surf City, NJ (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/421,880

(22) Filed: Apr. 10, 2009

Related U.S. Application Data
(63) Continuation-in-part of application No. 12/151,546, filed on May 7, 2008, now abandoned.

(51) Int. Cl. A63F 9/24; A63F 13/00

(52) U.S. Cl. 463/9; 463/25; 463/30

(57) ABSTRACT

A gaming machine activated, in one embodiment, by a wager has a database of words and a processor for operating a primary programmatic element wherein a plurality of letters each having a discrete point value are displayed in a scrambled manner on a first display and then rearranged to form a word found in the database. The player is invited to discard one or more letters, the processor replacing discarded letters and generating a word of the highest point value, which may be the original word or a word containing at least one of the replacement letters. A payout is calculated based on a payout schedule visible to the player and the total value of the letters in the word. Upon occurrence of a predetermined event or an invitation, a second programmatic element initiates a bonus round, issues a new group of randomly generated letters and places these letters onto a game board layout presented on a second display. A payout for the bonus event is calculated based on the point values of the letters and points provided at squares on the layout that the letters are placed on, in accordance with predetermined rules. The processor, in another embodiment, enables the play of a large number of games.

### CROSS REFERENCE TO RELATED APPLICATION(S)

This application is a continuation-in-part of U.S. patent application Ser. No. 12/151,546, filed May 7, 2008, which is incorporated by reference as if fully set forth.

### FIELD OF INVENTION

The present invention relates to gaming devices in general and, more particularly, to gaming machines based on puzzle games.

### BACKGROUND

Slot machines, video poker machines and other gaming machines based on computer generated random sequences and electronic displays are prevalent in the gaming industry. Such machines are extremely popular with players due to the endless possibilities for adding sound, action and programmatic elements to create entertainment value as well as enhance the perception of new and different games and thereby promote the perception of winning. Casinos are replete with competing machines and typically the expectation of winning for each machine is the same due to regulation, or is believed to be the same in unregulated environments. Players are attracted to challenging, entertaining and exciting machines, and there is a continuing need for gaming machine manufacturers to produce new games to attract players and increase play.

Many games have a “secondary” or “bonus” game played in parallel with or in sequence with a “primary” game. The bonus game can take many forms, either as a new “level” of the primary game, as a thematically connected game or as a simple random “bonus” with little or no connection to the primary game. Existing gaming machines typically have a bonus round which is initiated by a bonus triggering event occurring during the primary game of the gaming device. Typically, the bonus scheme provides the player with an opportunity to obtain a bonus, in addition to the a payout obtained as a result of the primary game.

Gaming machines based on word games are known in the gaming art. U.S. Pat. No. 6,428,412 to Anderson, et al., and assigned to WMS Gaming, discloses a gaming system in which arrangements of randomly-selected words generate respective payouts, and at least one of the letters of one word are shared by another word. A slot machine game based on the board game SCRABBLE® has been marketed by WMS Gaming which provides a bonus in which the player chooses from various objects, until finding three (3) “end of game” objects.

However, it would be desirable to provide players with new schemes for gaming devices to challenge players and add new dimensions to the game and thereby increase player enjoyment and excitement, as well as enhancing and inducing increased play to the benefit of gaming machine operators. In particular, it is desirable to provide an element of skill along with the random chance of winning prevalent in gaming machines. It is further desirable to provide additional bonus rounds in such a game, which encourages a player to engage in the added bonus rounds.

### SUMMARY

Accordingly, embodiments described herein are characterized by providing a new and improved gaming system comprising: a gaming device initialized by a players' response to an invitation to participate in the game. The initialization may also require making a wager or entering a unique code identifying the player and recognized and accepted by the gaming system. The gaming device, in one embodiment, is provided with a database of words and a processor for operating in accordance with a primary programmatic element wherein a given number N of randomly selected letters, each having a discrete point or numeric value are initially displayed in a scrambled pattern to a player on a first display. The N displayed letters and their associated point values are then automatically arranged into a word incorporated in the database. In a preferred embodiment, the gaming system processor displays a word having the highest point count, together with the point count of the displayed word. The player compares his total point count with the payout chart displayed adjacent to the total word count to determine his strategy. For example, if the total point count indicates he is entitled a payout, he may hold all of his letters and then hit the draw button or hold only the letters making up the winning word and discard the others before hitting the draw button. As other alternatives, the player may discard all of his letters anticipating a better second draw or may hold one or a few letters having high point values and discarding the others, anticipating he will draw letters that will spell a winning word with his high point values letter(s).

The processor responds to selective operation of the hold buttons (if any) and the draw button and randomly generates M letters, where N≧M≧0 for games played with seven (7) letters.

The processor then determines the highest point value word, calculates and displays the total point count for that word and calculates a payout based on the size of the player's bet, typically displayed as a number of credits and the point count range that player's total point count falls into and displays the payout. In one embodiment, payout may be directly displayed on the payout chart as well as a window provided as part of the display. As an alternative, the player may be invited to discard one or more of the displayed letters for a third draw. In response to a request for new letters, the processor replaces discarded letters selected by the player and then automatically generates and displays a new word of the highest point value and calculates and displays a payout, if any.

Upon the occurrence a winning hand, the processor determines if a particular event has also occurred. The particular event, triggers a bonus operation whereupon the processor, displays a game board layout, preferably a SCRABBLE® layout, randomly generates seven (7) letters and fits these letters onto words previously placed on the layout and calculates a bonus payout based on the point values of the bonus letters as well as points provided due to placement of the letters on letter spaces which, for example, may double or triple the letter or word placed on the board layout, in accordance with predetermined rules.

A system made in accordance with one embodiment of the present application preferably conducts a primary game and a secondary or “bonus” game. The program steps of the primary game are preferably provided in a programmatic element for controlling the processor to generate a random sequence of letters each assigned discrete point values and presented to the player on a first display and then automatically arranged into a word contained in the database and having the highest point value. The payout is based on the point value of the word and the payout criteria on the payout table. A secondary game has a programmatic element initiated upon occurrence of a predetermined event or a player's response to an invitation, and places a word on a representation of a board game layout displayed to the player on either the first display or a second display for embodiments having two (2) displays. The processor automatically arranges the word at a location on the board game layout in accordance with game rules contained in the programmatic element to obtain the highest value and pays out a bonus in accordance with a predetermined payout table. The predetermined event is preferably one of: a word having a specific point total, a random event, a totally random event occurring during the play of a game, at least a minimum number of letters are used to create the word (for example the word contains at least six (6) letters), or a special tile is randomly generated and given to the player in place of a letter. In certain embodiments, the processor, under control of a programmatic element, invites a player of the primary game to discard one or more of the original letters which are replaced by new randomly selected letters. The processor then generates a new word, employing the database and which may or may not have a total point value equal to or higher than the original word generated by the processor.

In one embodiment, the programmatic elements incorporate the rules of SCRABBLE® and the database comprises a standardized word list or a word list customized to a player's likes or interests. In another embodiment, the database includes definitions of the words in the database and the processor, in addition to rearranging the letters to create the word of highest point value, displays the definition of the word in close proximity to the display of the word created by the processor.

Methods of playing a gaming device are also disclosed.

### BRIEF DESCRIPTION OF THE DRAWINGS

FIG. 1 is a perspective view of one embodiment of a gaming system incorporating one or more of the features described herein;

FIG. 1a is a detailed view of the keyboard shown in FIG. 1 and used by a player to interface with the gaming system.

FIG. 2 is a simplified block diagram of a system which may be employed in the gaming system of FIG. 1.

FIGS. 2a-2e are views showing displays presented during the play of a game and which are useful in explaining the manner in which a game is played.

FIGS. 3a-3e, and 3i are flow diagrams useful in explaining the operation of the game under control of a processor provided in the system of FIG. 2.

FIGS. 3f and 3g respectively show the displays 20 and 30 of FIG. 1 in greater detail.

FIG. 3h is a simplified diagram showing the manner in which the game may be played using a wireless unit.

FIG. 3i is a flow diagram useful in explaining substantially simultaneous play of a plurality games by a player.

FIGS. 3j-3l are displays useful in explaining the flow diagram shown in FIG. 3i.

### DETAILED DESCRIPTION OF THE PREFERRED EMBODIMENTS

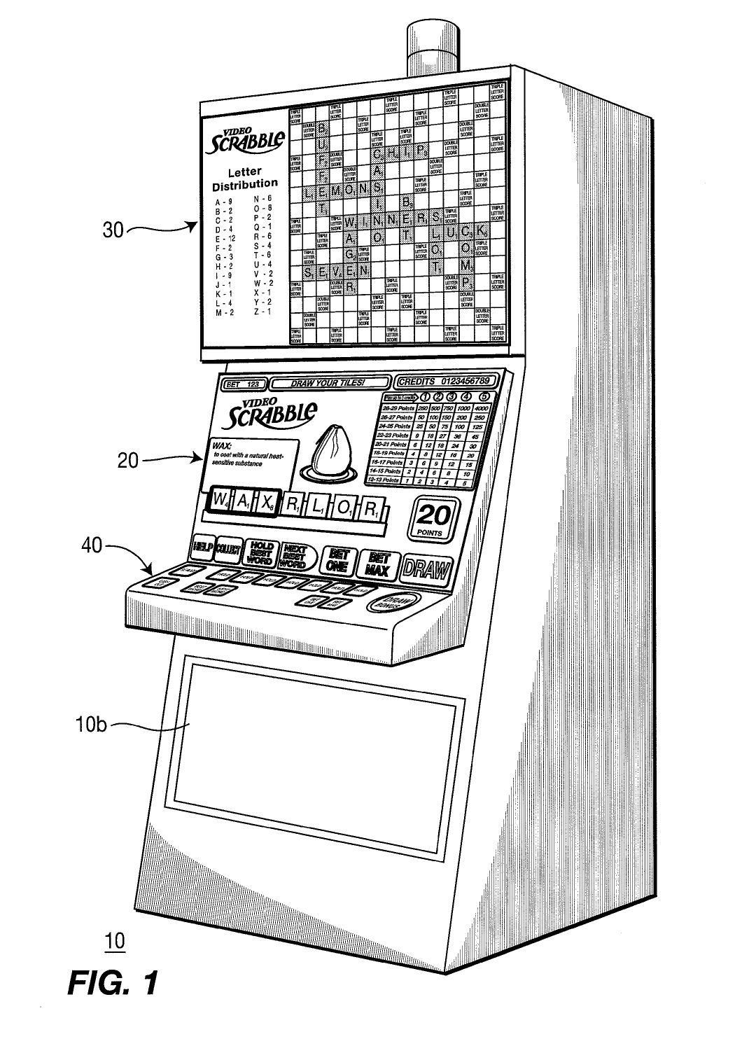

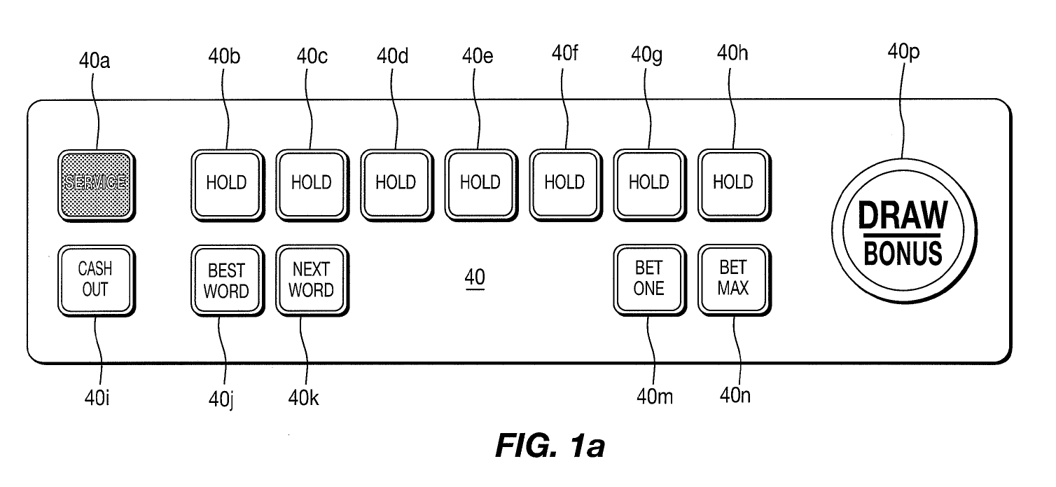

FIG. 1, shows a gaming device 10 configured to implement a game according to the present application. The gaming device 10, in one embodiment, has lower and upper visual displays 20 and 30 that may be any one of a CRT, LED, LCD, electro-luminescent, or other similar video display screen known generally in the art. One of or both of the displays 20 and 30, in one embodiment, includes a touch screen for interfacing with a player. In one embodiment, the gaming device 10 is programmed to play a game of chance based on the popular crossword game SCRABBLE®. In this embodiment, the gaming device conducts a primary game and a bonus game typically triggered by a given event which occurs during the primary game. It will be appreciated, however, that the gaming machine 10 may be implemented as a crossword puzzle or similar word game themes other than SCRABBLE®.

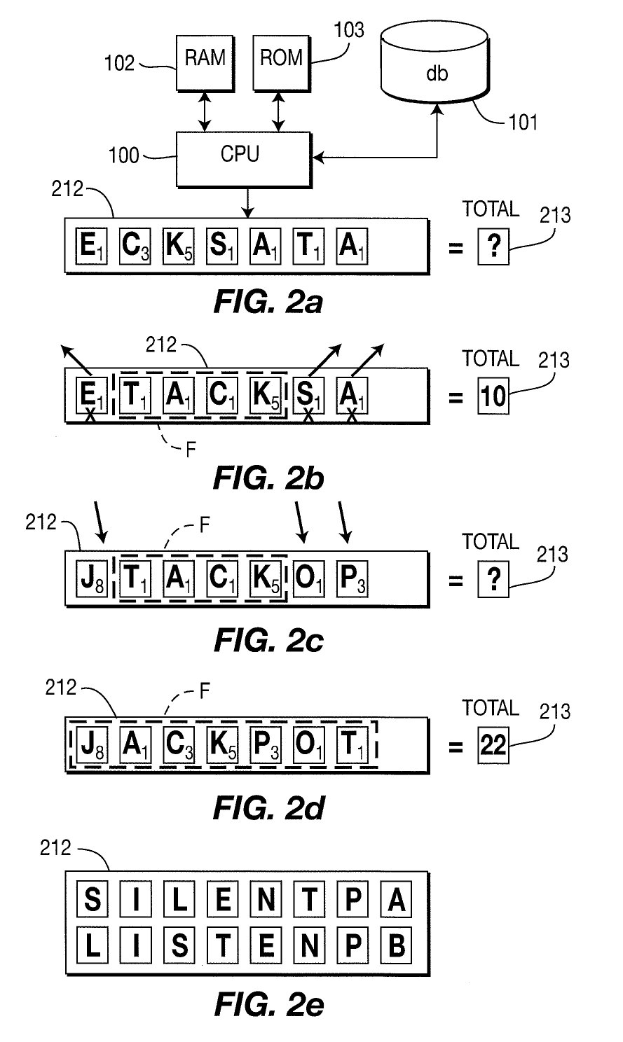

FIG. 2 is a simplified block diagram illustrating the basic logic circuitry and elements for the play of a game in accordance with one embodiment of the present application, and illustrates representations of the manner in which words are formed and selected in one embodiment of a primary game. In the illustrated embodiment of the present invention, a database 101 comprising a plurality of words, referred to herein as a vocabulary, is provided. The database 101 may either be a word list or preferably also include definitions of the words in the word list. The database 101 may be any or more of a number of available databases of words, such as words in general use, a game specific subset, e.g., a “SCRABBLE®” word list or a narrower set of words related to a theme, such as popular movies or a generic theme such as “The Old West.” The database 101 is in turn connected to or otherwise programmatically accessible by a processor 100 such as a CPU. Typically the processor 100 includes one or more microprocessors and associated machine readable memory devices such as a random access memory (RAM) 102 and one or more read-only memories (ROMs) or programmable ROMs (i.e., PROMs, EPROMs, EEPROMs, SPROMs) embodying the software program to enable the CPU 100 to conduct all aspects of the game. The ROMs, PROMs or other equivalent machine readable devices are also referred to herein as programmatic elements.

The programmatic elements employed in the processor 100 have the functionality to create a random sequence of letters. Discrete point values are assigned to the letters in advance and in readiness for play. In one embodiment, the discrete point values are those assigned in accordance with the standard rules of SCRABBLE®, although other schemes of assigning point values are used in alternate embodiments. Moreover, in certain embodiments, the point values can randomly change or be re-assigned to add further excitement and interest in the game. For example, a letter might have its point value randomly changed to another value, or the initial value may be multiplied by a factor. Thus, a player may anticipate the possibility of gaining points based on the “luck of the draw.” At the start of play, a finite number N of letters, most preferably seven (7), are randomly generated and distributed to the player and displayed in scrambled fashion on a first display screen 20 as shown in FIG. 2a. The processor 100, controlled by a programmatic element, such as a ROM, PROMs or the like then automatically rearranges all or less than all of the letters into a word with the highest point value, as shown in FIG. 2b and surrounds the word with a frame F. In some preferred embodiments, no “wildcard” is available and discrete identifiable letters are displayed. Algorithms for determining the highest point value word from the randomly drawn letters are known, and operate in conjunction with the database 101, which contains the permissible vocabulary, and programmatic elements, such as memories 102 and 103 described above and shown in FIG. 2. The word and its point value are then displayed on the lower display 20 and the point total correlated to a pay table that is also displayed to the player. The payout table is preferably part of the display screen of the lower display or any suitable region clearly visible to the player, such as region 10b.

In accordance with one aspect of a preferred embodiment, the player may next choose one or more letters to discard. For every letter discarded, a new letter is randomly generated and displayed in scrambled fashion. The processor then regenerates a word that is typically of as high or higher total point value as the previous word, but may be a lower point count than the original word. Said another way and in one embodiment, if the letters that replace the discarded letters do not permit a higher point value word to be created, the first created word is retained, in one alternative embodiment. However, the game is preferably programmed to permit a player to risk receiving a lower point total by holding only high value letters of a short word or holding high value letters which fail to create a word with the remaining letters in the hope of creating a word of greater total point value if the next random letter or letters permits creation of a such a word. As one example, in a game of poker, this is analogous to discarding one ace of a pair of aces in the hopes of drawing a straight or a flush. Thus, the player may elect to discard any of the letters forming the word, or even discard all N of the letters initially provided to the player. However, the player assumes the risk that the subsequent set of letters may create a word of lesser total point value or perhaps not spell a word at all. In certain embodiments, further rounds of discarding and drawing new letters can be added. However, in a preferred embodiment, a payout is awarded once the first discard and letter replacement sequence is complete.

The process of discarding letters is shown in FIGS. 2a and 2b, which illustrate a first set of scrambled letters (FIG. 2a) and which form the word T-A-C-K and three other letters E-A-C (FIG. 2b). The word is clearly identified and distinguished from the remaining letters by the frame F. If the latter three letters are discarded, the word “TACK” will remain and additional letters are randomly drawn to replace them with the hope of obtaining a word having a higher total point value. As seen in FIG. 2c, if the letters J-O-P are drawn, the processor 100 automatically rearranges the letters to form “JACKPOT” together with their total point count, as shown in FIG. 2d.

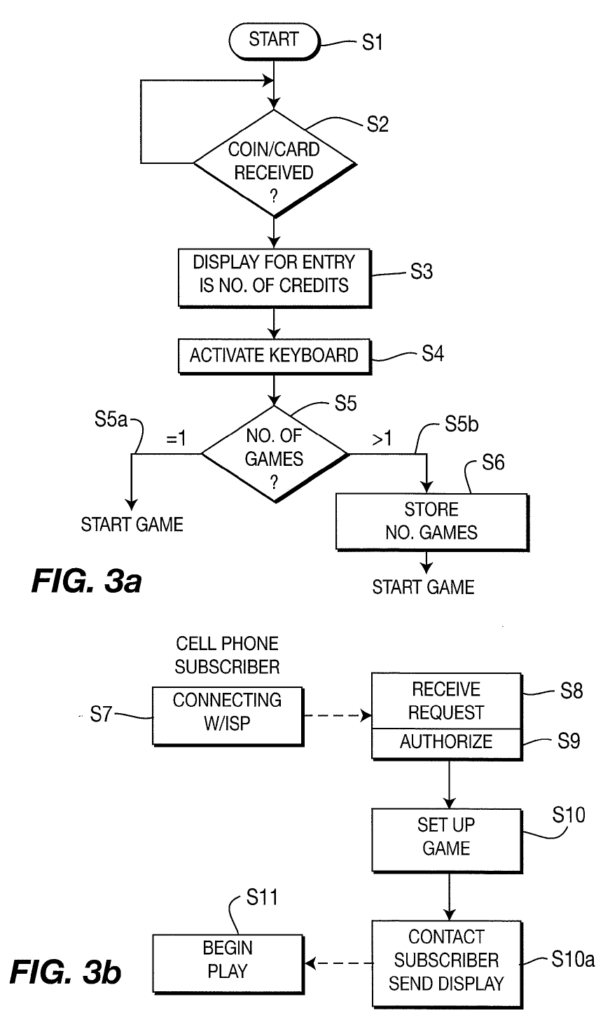

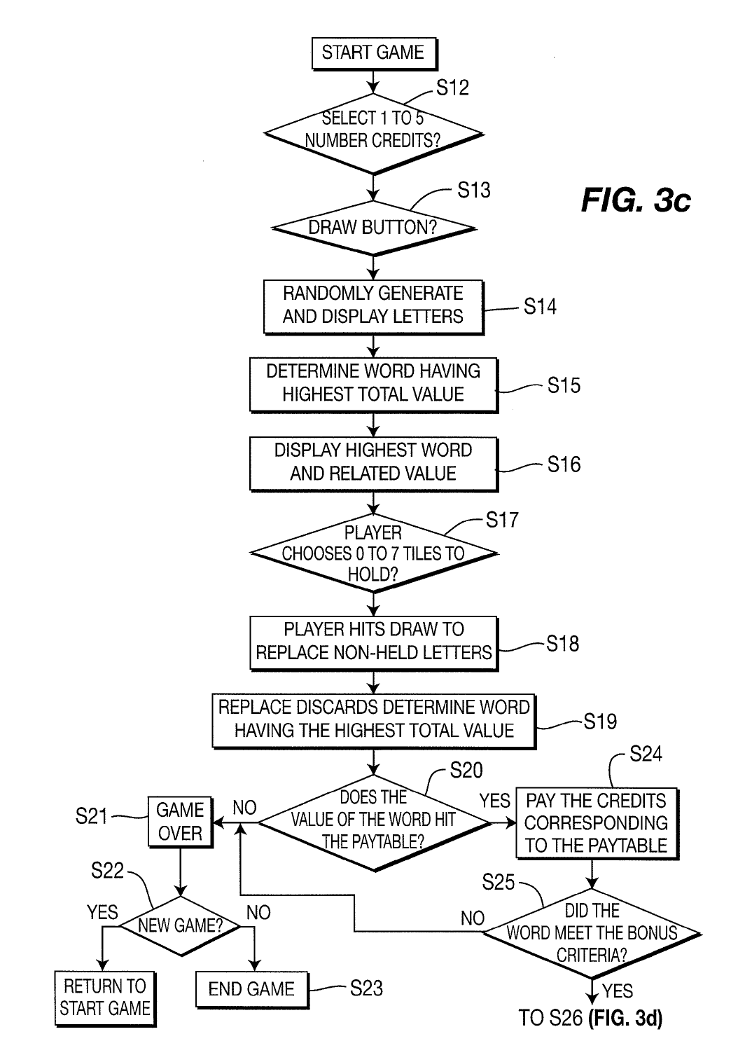

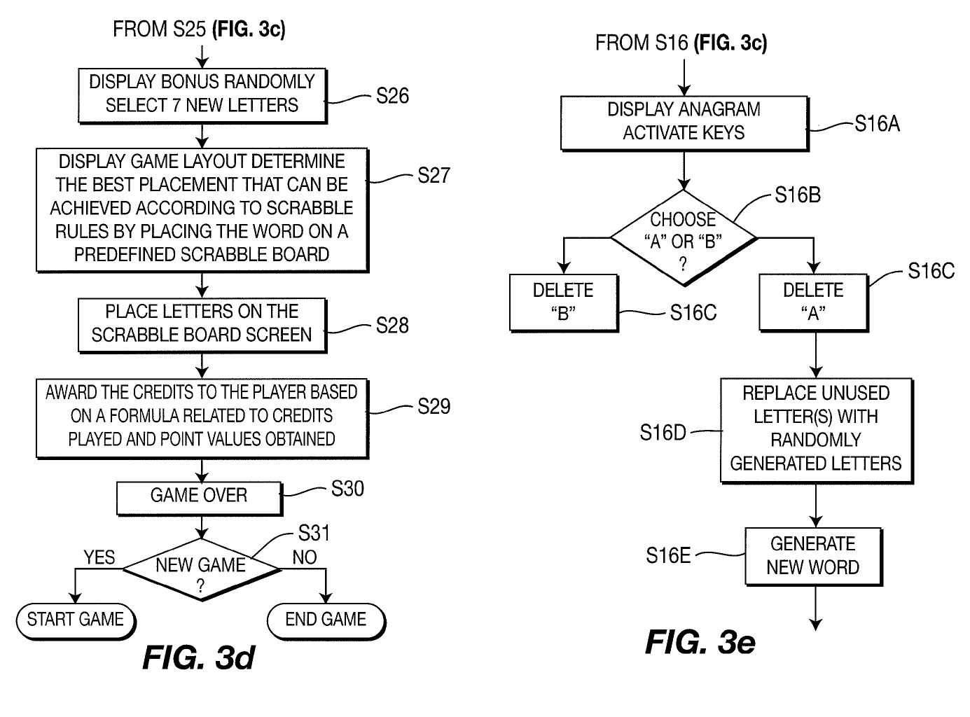

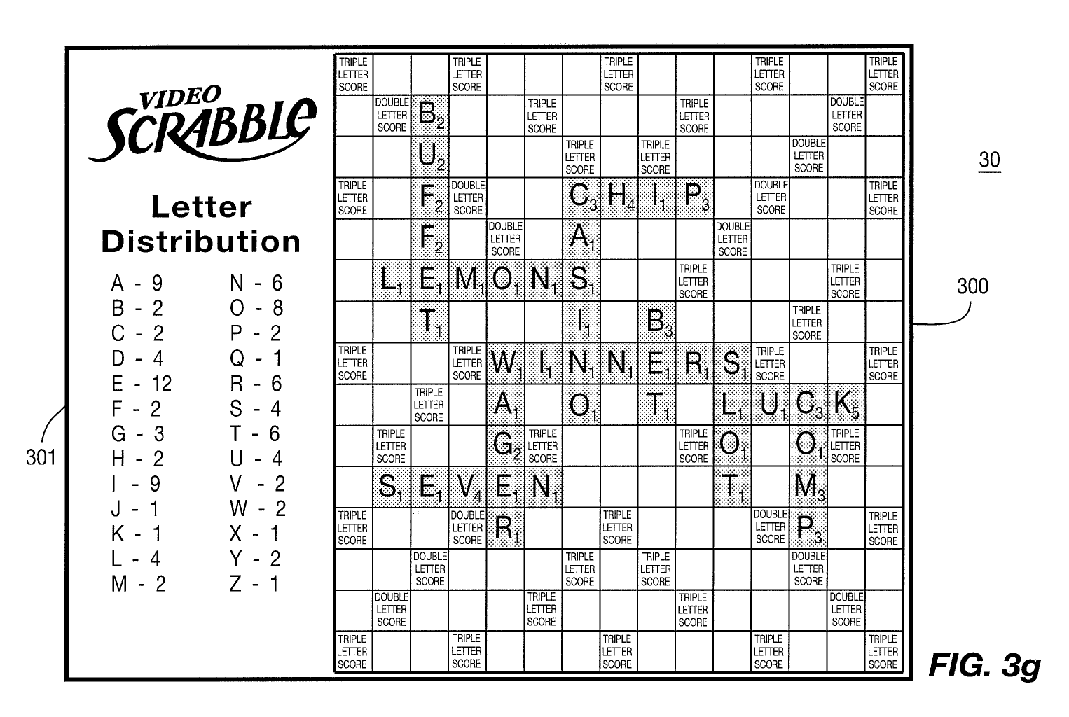

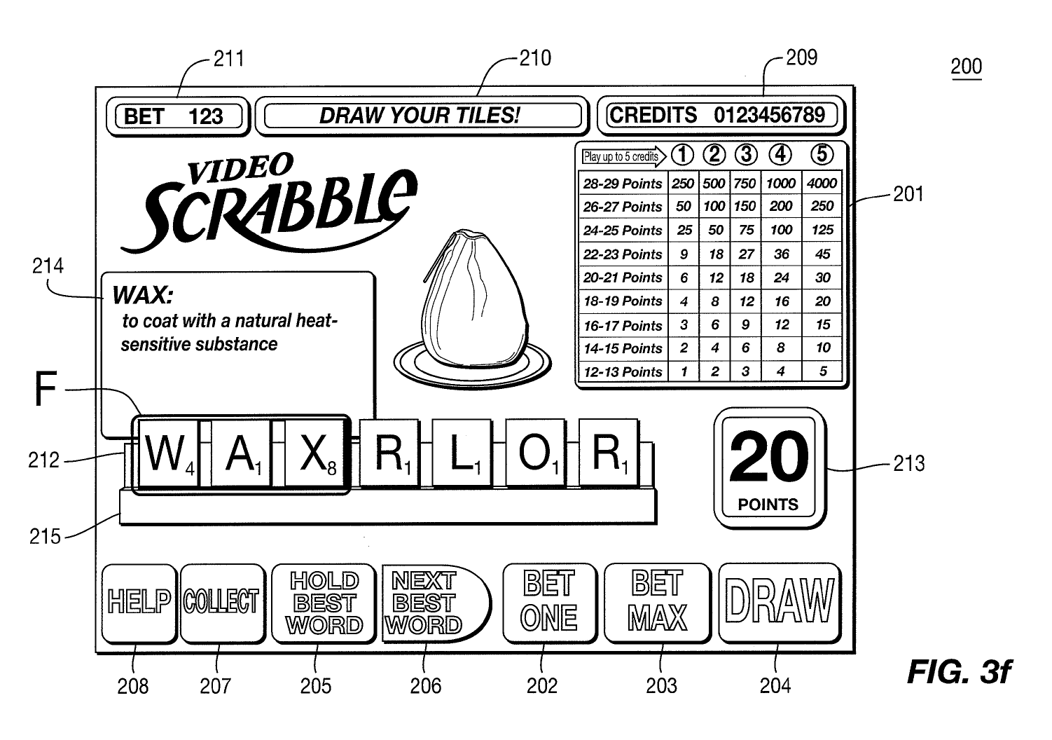

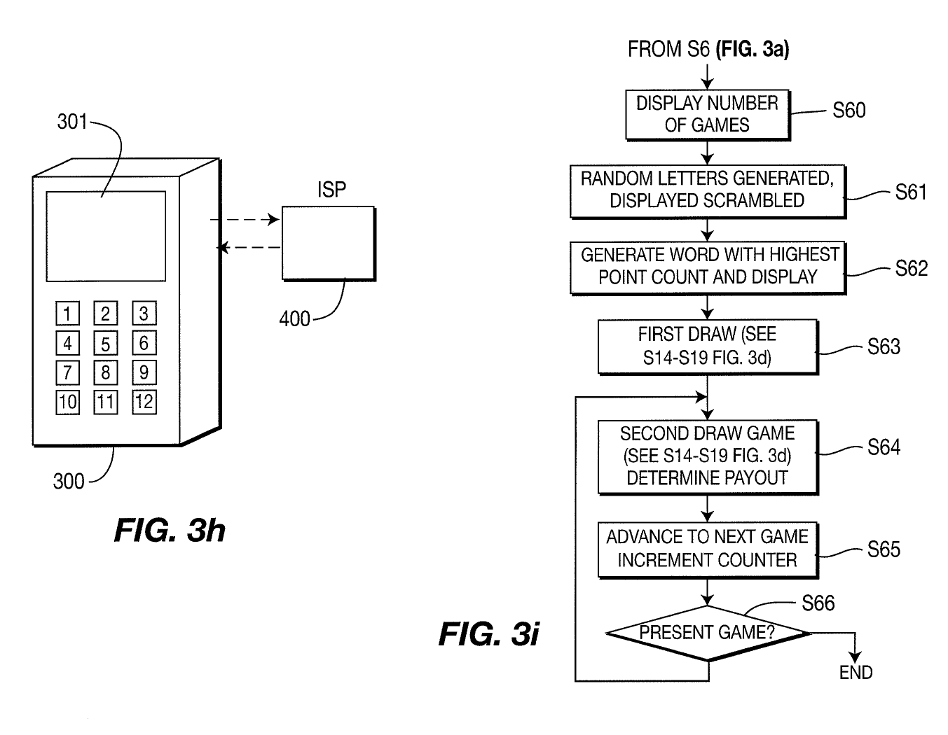

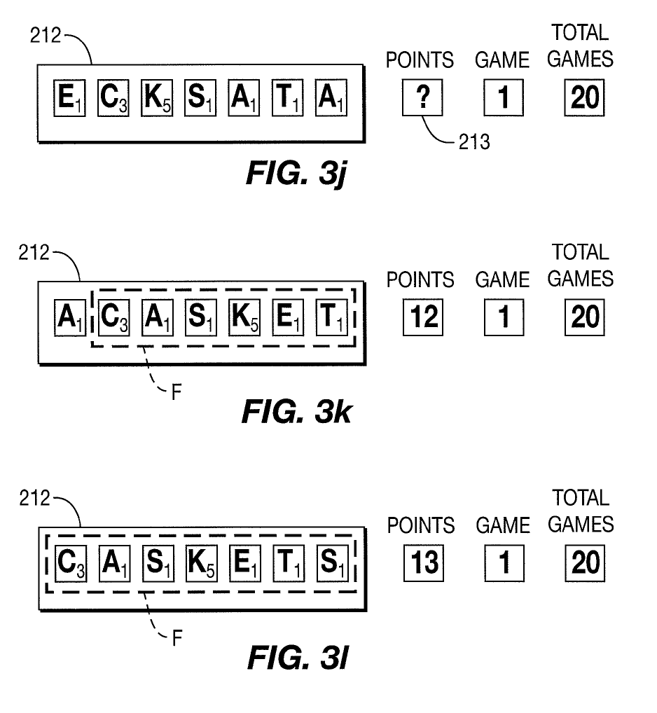

In another aspect of certain embodiments, regardless of the number of letters retained or discarded, it is possible that the word formed from the letters will be a one word anagram in which the same group of letters can form more than one word, such as CREATIVE/REACTIVE, DEDUCTIONS/DISCOUNTED or LISTEN/SILENT, in an example where eight (8) letters are provided to a player, as shown in FIGS. 2d and 2e. In the instance of a one-word anagram, a function is provided as part of the program enabling a player to scroll through words. In the embodiment of the keyboard shown in FIG. 1a, the player may view the anagram words by selectively operating the BEST WORD and NEXT BEST WORD keys 40j, 40k forming part of the keyboard array 40 provided just below display 20. Although the words will by definition be of equal point value, the player may plan his strategy which can be part skill and part luck by selecting the “right” one of the two (2) displayed words, as will be set forth below in more detail. Additionally, it is possible that one word is perceived to be easier to further modify as additional “tiles” i.e., letters are drawn. Thus, if in one embodiment the selection of a word after scrolling is made permanent and letters are discarded, the choice does include an aspect of skill. For example, in a case where eight (8) letters are provided to a player, “LISTEN” may be chosen over “SILENT” since the probability i.e., chance of drawing an “S” as one of the two (2) discarded letters is greater than the chance of drawing an “L” and a “Y” to replace the two (2) discarded letters, and the player thus assumes the risk that the chance to draw an “S” to spell “LISTENS” is better than the chance to draw “L” and “Y” to spell “SILENTLY.” The flow diagram for anagrams is shown in FIG. 3e and is described below in detail. In other embodiments where anagram pairs can be toggled at any time, this aspect of skill is not available.

In another embodiment, upon occurrence of a predetermined event, the primary game described immediately above is concluded and the player is awarded with a bonus game, which, in preferred embodiments, takes place on the upper screen 30 shown in FIG. 1. However, in other embodiments, where only one screen, such as the lower screen 20, is provided, the single screen is configured to also display the bonus game, either via split screen, picture within a picture, or by replacement of the image. The pre-determined event may be any of a number of events such as: achieving a specific point total for a word, using at least a given minimum number of letters to form the word, a random event such as drawing a “star” letter or “red” letter (that is, a letter with a special designation or color), or a totally random selection or timeout of a random time interval during the play of a game. Responsive to the event that occurs, a BONUS message is displayed, the processor randomly generates letters displayed in scrambled fashion to the player and then rearranges the letters to create a word which is added to the game board layout or adding the letters to a word or words already present on the game board layout which is a representation of a board game layout, e.g., of a SCRABBLE® board, or a crossword puzzle board for another example. The processor, in one embodiment, automatically replaces the word and/or letters on the layout in accordance with a set of pre-defined game rules to obtain the highest total point value similar to the manner described above for selecting a word with the highest point value.

As in traditional board games, the portions (i.e., “squares”) of the board that are overlaid with the letters determine the point total (for example “triple letter bonus” squares) and the words are typically arranged in accordance with a set of rules, typically including that a letter is shared. After the word or words are arranged on the game board layout, a bonus payout is calculated based on a point value table displaying the point value of each letter and on the placement of the words, as well as the point values of the game board squares the letters occupy. Points are also awarded for original words which have been modified. For example, adding a letter “S” to the word “DECK” previously presented on the layout entitles the player to the total point value of the word “DECKS” and not simply the point value of the letter “S.” The processor calculates the total points achieved by the player and presents this on display 30 separately from the payout achieved by the player in the first game and presented on display 20.

In any of the above embodiments, an added entertainment feature of the gaming system disclosed herein is that the definitions of the words generated are presented on display 20 directly above the word. See FIG. 3f showing the word WAX at 212 and the definition of the word WAX in area 214. In certain embodiments, a multiple choice game for additional payout based on the definitions of words is provided.

The program performed by the processor is stored in one or more of the memory devices such as a PROM 103 or ROM 102, to perform the program steps set forth in flow diagrams shown in FIGS. 3a to 3e and 3i.

FIG. 3a is a flow diagram of the program steps performed by the gaming device for conducting the basic game. At the start step S1, the program is initiated by insertion of a wager. For example, initiation of the program may occur responsive to insertion of a card such as a credit card or debit card or a “house” card issued by an establishment providing the gaming systems such as system 10 shown in FIG. 1. A “house” card may be either one of a credit card type or a prepaid type in which a player requests the house to provide a prepaid or credit-line amount in the card. The card may be inserted into a slot, such as slot 10a provided with a reader for reading the contents of the card and reducing the prepaid amount on the card or forwarding the costs of the play through a wireless or wired connection (not shown) to the credit card company or gaming establishment that issued the player's card. Alternatively, or in addition to credit cards, gaming device may accept paper currency or coins of the type that are either issued by the “house” or that are standard legal currency which, in the case of U.S. coins would be a 50 cent or 1 dollar type coins, for example. Alternatively, the player may insert a code uniquely identifying the player as authorized by the “house” to be advanced credit to play the game.

In the event that a credit or debit card is inserted and in the event that currency which is greater in amount than that required for the play of one (1) game, receipt of the coin or card is acknowledged at S2. If no coin or card has been received, the program returns to step S1. When one or more coins or other acceptable entry has been received and acknowledged/approved, the program advances to S3 to display a message displaying the number of “credits” the player has stored in the gaming device in window 209 of FIG. 3f and inviting the player to enter the number of games the players wishes to play in window 210 of FIG. 3f. FIG. 3f, which will be described below in greater detail displays the number of credits available to the player and, in one embodiment, provides for a wager of from one (1) to five (5) credits for one game. As was described above, display 20 may be associated with a key array 40 as shown in FIG. 1a or incorporate a touch screen having a keypad with keys appropriate to enter the number of games, as well as performing other functions. At S4, the keyboard 40, shown in FIGS. 1 and 1a, is activated by the processor and the processor looks for the keyboard entry at S5. If only one game is entered, the program branches at S5a to start the game. If a number of games greater than 1 is entered, the program branches at S5b and stores the number of simultaneous games to be played at S6 and then provides a signal to initiate the start of the game. In one embodiment, a player preferably may enter a request to play a large number of games simultaneously as will be described in greater detail in connection with FIG. 3i. Selected keys of the key array 40 may serve dual functions to provide for entry of a large number or additional keys (not shown) are provided to enter a large number of games. Making reference to FIG. 3f, showing a detailed view of one embodiment 200 of display 20 shown in FIG. 1, a payout table 201 is comprised of a left-hand column showing the winning point categories and the columns headed “1” through “5” set forth the number of credits each winning hand is worth according to the number of “credits” wagered by a player. For example, assuming a player desires to wager four (4) “credits, he presses the “BET ONE” button 202 provided along the bottom of display 200, which, in this embodiment, is an interactive touch screen, four (4) times. Each time button 201 is pressed, one of the numbers “1” to “5,” arranged along the top row of the payout table, is illuminated. FIG. 3f shows the number “4” illuminated. A “BET MAX” button 203 is provided to enable immediate selection of the maximum bet (5 credits) by pressing button 203 once, thereby illuminating the number “5” at the top of the payout chart. As an alternative to the touch screen the buttons of the keyboard array are provided adjacent to the bottom of display 20, as will be more fully described. When the desired number of credits is illuminated, the game is initiated by pressing the DRAW/BONUS key 40p.

The stored program shown in FIGS. 3a, 3c-3e and 3i may be modified for play of the game over a wired network or a wireless network, such as the Internet. As shown in FIG. 3b, a cell phone, laptop, PC, PDA or other like device, at S7,1 contacts a service location or website of a service provider, such as an Internet Service Provider (ISP) offering the game. The ISP, at S8 receives the request, typically over a wireless channel although a wired channel or a combination wired and wireless channel may certainly be utilized as an alternative. The ISP receives the request at S8, checks authorization at S9, initiates the game program at S10 and conveys the game to the subscriber's cell phone or the like at S10a for display. The subscriber begins play at S11.

Insofar as the authorization step, S9, is concerned, the person requesting play, as an alternative to being a subscriber may be a one (1) time user so that when the ISP receives the request at S8, billing information is requested whereby the user enters credit or charge card information in order to play the game. As an alternative, with regard to cell phone users, charges for play of the game may be added to the account of the cell phone user as will be described in connection with FIG. 3h.

FIGS. 3c and 3d, taken together, comprise the flow diagram for play of the basic game and the bonus event. When appropriate entry of requested information is obtained by the gaming system 10 shown in FIG. 1 which is derived from either one of the programs shown in FIG. 3a and FIG. 3b, the game starts, whereby the player, after being invited to begin a game wherein the processor displays PLACE YOUR BET in window 210 of FIG. 3f, at step S12 by selective operation of buttons 40m, 40n in FIG. 1a, enters the desired wager, which may be from “1” to “5” credits as described above, the selected number of credits being illuminated on the payout screen 201 and the number of credits bet being displayed in window 211. The player then presses the “DRAW/BONUS” button 40P at S13 causing the processor, at step S14 to respond by randomly generating seven (7) letters and displaying the letters in scrambled fashion as shown at region 212 of the display 200, for example. Each letter is displayed together with a numeric value associated therewith. In the display shown in FIG. 2a, each letter and its associated numeric value is shown in the display area 212. In one embodiment, the image of each letter simulates a three-dimensional “tile” typically encountered in the SCRABBLE® board game placed on a simulated “holder” 215 in FIG. 3f. A window 213 having the label “POINTS” presents the total count. At the program stage shown in FIG. 2a, since the letters are scrambled and no word has yet been created, the points display is blank.

The program then advances to step S15 whereupon the processor performs an algorithm to determine the word having the highest total count in conjunction with the vocabulary provided in database 101 shown in FIG. 2. The processor, at S16 displays the word in area 212, the total point in window 213 as shown in FIG. 2b and further displays the definition of the word in area 214 shown in FIG. 3f. The processor creates a frame F shown in FIGS. 2b and 3f, which surrounds the letters forming the word and the total point count for the displayed word is provided in the “POINTS” window 213.

At this point in the game, the player compares the total in the POINTS window with the payout chart to determine his next move. For example, the total point value of the word may be less than the total needed for a winning hand. As a result, the player may want to discard all of his letters anticipating a draw of all new letters will be more favorable. This is accomplished by pressing the DRAW button, causing all of the letters to be discarded. As another example, the player's word may be sufficient for a payout and but the word is made up of less than all seven (7) letters causing the player to hold only the letters needed for the word and discard the remaining letters, anticipating the newly drawn letters may either add to the existing word or create a word of greater value than the present word. This is accomplished by pressing the HOLD BEST WORD button and then pressing the DRAW button, causing the processor to discard the letters E, S and A, shown in FIG. 2b, and randomly generating the letters J, O, P shown in FIG. 2c. As still another alternative, the player may hold some letter or letters having a high point value and discard the remaining letters, anticipating that the newly drawn letters, together with high point value letters will provide a payout. This is accomplished by pressing the one or more of the HOLD buttons 40b-40h, each being directly beneath one of the seven (7) letter displayed in area 212, and then pressing the DRAW button 40p.

The keyboard 40 in FIG. 1 and shown in detail in FIG. 1a, includes an array of keys which includes a SERVICE key 40a (pressed when the gaming device malfunctions), BEST WORD key 40j, NEXT BEST WORD key 40k, BET ONE key 40m, BET MAX key 40n and DRAW/BONUS key 40p. In the example given in FIG. 2b, presuming the player is satisfied with the word “TACK” the player, at S17 in FIG. 3c, invited by the message DRAW YOUR TILES displayed in window 210 of display 200, presses the BEST WORD button 40j and then presses the DRAW/BONUS button 40p at S18. The processor responds at S19 by removing the discarded letters, replacing them with randomly generated letters J, O and P displayed at 213 together with the word “TACK” and then utilizes the database to determine the word having the highest total value. together with the letters J, O and P, as shown in FIG. 2c.

The new word, “JACKPOT” is automatically generated and displayed together with the total numeric value “22” in window 213. The processor, at S20 compares the total points in window 213 with the chart 201, also stored in a memory (not shown) to determine if the value of the word is entitled to a payout. If the total value is less that the lowest payout (12-13 points in chart 201) the program branches to S20 (GAME OVER) and waits for the player to start a new game by entering the desired number of credits. Alternatively, the player may cash out at by pressing the CASH OUT KEY to dispense a card (with a magnetic stripe) or prints a secure receipt which may be redeemed for cash or stored in the player's account with the gaming establishment.

As another alternative to providing only one draw, a player may engage in one or more draw operations similar to that described above by modifying the program to repeat steps S14 through S19 before performing step S20.

Returning to step S20, if the point value is at least 12 points, the processor, at S24, determines the payout based on the size of the wager and the total points in window 213, and adds this payout to the credits (if any) in window 209. Payout of the player may take any one of a variety of other payment forms such as returning coins, adding a value to a “house” card held by the player or to a player's “house” account, transferring the value of the win electronically to the player's house account, as well as retaining a total value of the credits at window 209. In the event that the player's running total is maintained in the gaming device, the “CASH OUT” selection may be operated by the player.

The payout at S24 triggers the processor to determine, at S25 if the criteria for a bonus is present. The criteria may be any one of: the word is at least six (6) letters; the player is provided with a tile having a special indicia such as a star, WILD or other marking; the payout occurred during an interval randomly generated by an internal clock in the processor. Upon the occurrence of a bonus event, the processor, at S26, displays “BONUS” on display 20, and randomly generates seven (7) letters and displays them in area 212. At S27 the processor displays the game board layout on display 30 and determines the best placement of the letters on the game board in combination with words previously placed on the game board to achieve the highest point count and places the letters on the game board at S28.

At S29 the processor calculates the number of credits awarded to the player based on the number of credits wagered by the player in the base game, the point values of the letters placed on the game board and the DOUBLE LETTER SCORE, DOUBLE WORD SCORE, TRIPLE LETTER SCORE and TRIPLE WORD SCORE squares occupied by the player's letters placed on the game board. FIG. 3g is a detailed view of the display 30 comprised of game board 300 and letter distribution chart 301.

FIG. 3e shows a sub-program, in which an additional element of skills/risks are introduced. Initially, making reference to FIG. 3c, it is assumed that the processor has determined the word having the highest total count, at S14, in the example given above, is capable of creating an anagram using six (6) of the seven (7) randomly generated letters provided to the player. Assuming that six (6) of the seven (7) randomly generated letters provided to a player spells either “SILENT” or “LISTEN.” Given this example, as shown in FIG. 2e, both words of the anagram are displayed one beneath the other and having an identifier to the left of the word such as “A” and “B.” This occurs at step S14a wherein the processor activates the keyboard and displays “SELECT ANAGRAM A OR B.” The processor looks to see if “A” or “B” is chosen by the player selectively pressing one of the BEST WORD and NEXT BEST WORD keys 40j, 40k, shown in FIG. 1a. Assuming, “A” is selected, the anagram associated with “B” is deleted at S14c and, at S14d, the letter “P” is replaced with a randomly generated letter and at S14e, the new word, if possible, is generated. Similarly, if “B” is chosen, “A” is deleted at S14c′. The letter “P” is replaced by a randomly generated letter at S14d and the new word (if any) is generated at S14e, whereupon the program advances to step S15. In an alternative embodiment, the keys 40j, 40k are operated to enable the player to choose between the best and next best word. When the player decides which of these words he prefers, the preferred word is retained by pressing the appropriate key 40j or 40k and then pressing the DRAW/BONUS button 40p. It should be noted that the best and next best words may have a different number of letters, adding to the excitement and strategy options available to the player.

The games described herein may alternatively be played from a cell phone 100 shown in FIG. 3h which accesses an internet service provider (ISP) 400. The wireless unit 300 accesses ISP 400 through the Internet and, upon obtaining the desired website, is invited to participate in the game described herein, the ISP 400 being provided with the processor, memory devices and database shown in FIG. 2. The ISP 400, in addition to generating the messages to be presented on the screen 301 of wireless unit 300 using the program steps shown in FIGS. 3c-3d, identifies the keys to be operated in order to achieve the results obtained using the more customized key inputs described above. For example, assuming a typical telephone keyboard having keys “0-9,” “#” and “*,” “YES” and “NO” responses may be obtained through the use of the “#” and “* keys, respectively. Obviously, other key assignments may be adopted. FIG. 3h shows a wireless unit 300 having a 12 key keyboard. Other wireless devices having larger keyboards such as a “qwerty” keyboard or other keyboards having a larger number of operating keys may be used wherein the program is modified to accommodate the type of wireless device used by a player. The wireless unit may include wireless cell phones, PDAs, portable laptop computers having broadband or other access capabilities to the internet. The game may be played with or without betting and in the event that the game provides for betting and payouts, these capabilities may be achieved through acceptance of credit card information or registering with the ISP to set up an account to handle such matters, where they are legally permitted.

FIG. 3i is an example of a program enabling a player to simultaneously play a plurality of games. Making reference to FIGS. 3a, 3i and 3j-3l, assuming the player wants to play 20 games, after the number of games is entered at S5 in FIG. 3a using keys (not shown) appropriate to entering a numeric amount and stored in memory at S6, the program advances to S60 in FIG. 3i, the processor displaying the number of games selected, as shown in FIG. 3j. At S61, the processor randomly generates seven letters and presents them scrambled on the display 20 (see FIG. 1) or 200 (FIG. 3f). At S62 the processor accesses the database 101 to generate the word having the highest point count using the scrambled letters and displays the word and point count in substantially the same manner as shown in FIG. 3f. The letters held by the player at S62 and displayed at 212 in display 20 are the same for all twenty (20) games. A first draw phase is conducted at S63, the processor performing substantially the same steps as steps S14-S19 shown in FIG. 3c. The randomly generated replacement letters provided to the player are the same for all 20 games. In the example, all twenty (20) hands hold the letters shown in FIG. 3j.

The randomly generated letters are displayed in scrambled fashion and are then rearranged to generate the word “CASKET” of point count “12,” as shown in FIG. 3k.

After the first draw is completed, the player is invited to make a second draw for the first of the 20 games, at S64. Initially, a game counter is set to “zero;” i.e., cleared and the game counter is incremented by one count. The count in the game counter is compared with the stored number of total games being played (“20”) and since this count (“1”) is less than (“20”), the processor performs the steps substantially as set forth at S14-S19 of FIG. 3c. In the example given, the player discards the unused letter “A” and draws a randomly generated letter “S” resulting in the word “CASKETS” for a point count 13 in game 1, shown in FIG. 3l. It should be noted that although each of the second draws is “random,” as are the “first” draws, the results of the 20 “second” draws will vary in a random fashion and thus be different for each of the 20 games. The processor calculates the payout and advances to step S65 to perform the “second” draw for the next game of the 20 games.

At S65, the count of the number of games is increased by one and compared against the number of games selected by the player and, since the count is less than 20, at S66 the program returns to S64 for the draw of letters for the “second” game, repeating steps S14-S19 and displays the word at 212, point count at 213 and game number in the Game window. The letter “S” is randomly drawn and the letters are rearranged to create and display the word CASKETS and the Total Count (13). Payout is preformed in the same manner as was previously described. This routine of steps is repeated until the counter being incremented, S65 has accumulated a count equal to the number of games selected by the player, whereupon the program branches at S66a, terminating the multiple game play. It should be understood that in the second and subsequent games, the player may break up the word CASKET, and discard some or all of the seven (7) letters he holds.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

What is claimed is:

1. A gaming device for use by a player, comprising:
a database containing a vocabulary of words;
a processor;
said processor being configured to:
randomly select a given number N of letters, each having a given value associated therewith;
present the randomly selected letters on a display;
rearrange M of the N letters on the display into a word found in the database, where 1≧M≦N; and
calculate a payout based on a value of the letters in the word.

2. The gaming device of claim 1, wherein the processor is further configured to base the payout on a payout table which is visible to the player.

3. The gaming device of claim 1, wherein the processor is configured to initiate random selection of said N letters responsive to a wager.

4. The gaming device of claim 1, wherein the processor is configured to retrieve from said database a definition corresponding to the word on the display.

5. The gaming device of claim 1, wherein the processor is configured to create a word which has a highest point value retrieve from said database.

6. The gaming device of claim 5, wherein the processor is configured to retrieve from said database a word of next highest point count responsive to operation of a NEXT BEST WORD key.

7. The gaming device of claim 6, wherein the processor is configured to remove the next highest point count word from the display and replace it with the highest point count word responsive to operation of a BEST WORD key.

8. The gaming device of claim 1, said processor being further configured to present a first draw invitation on said display inviting a player provided with said N letters to engage in a draw operation to discard zero or more of said N letters entered on an input device by said player and provided to the processor.

9. The gaming device of claim 8, said processor being further configured to present a second draw invitation on said display requesting said player to identify a number of letters from zero to N to be discarded responsive to the player's response to the first draw invitation entered on the input device by said player and provided to the processor.

10. The gaming device of claim 8, said processor being further configured to randomly generate from zero to N replacement letters each having a given value associated therewith and place each randomly selected replacement letter at a location on the display presently occupied by discarded letters responsive to an entry on the input device identifying the location occupied by the letters, if any, selected to be discarded and conveyed to the processor by the input device.

11. The gaming device of claim 9, said processor being further configured to determine a word of highest point value in said database based on letters held by the player after said draw, compare the highest point value of the word determined after the draw with the word of highest value determined before the draw and display that word having highest point value based on said comparison.

12. The gaming device of claim 11, the processor being configured to rearrange M of the N letters on the display into the word determined after the draw.

13. The gaming device of claim 12, said processor being further configured to determine a payout based on the highest point value of the word displayed after the draw.

14. The gaming device of claim 13, said processor being further configured to determine the payout further based on a payout table visible to the player.

15. The gaming device of claim 8, said processor being further configured to:
present a game board layout on the display responsive to a given event;
randomly generate N bonus letters;
present the bonus letters on the display in a scrambled fashion; and
place the bonus letters on the game board layout.

16. The gaming device of claim 15, wherein the game board layout is a second display independent of the first mentioned display.

17. The gaming device of claim 15, said given event being a random event.

18. The gaming device of claim 8, said processor being further configured to:
present a game board layout on the display responsive to a given event;
randomly generate N bonus letters;
present the bonus letters on the display in a scrambled fashion; and
present an invitation to the player to place said bonus letters on the game board layout.

19. The gaming device of claim 18, wherein the game board layout is a second display independent of the first mentioned display.

20. The gaming device of claim 18, said given event being a random event.

21. The gaming device of claim 18, said processor being further configured to:
place the bonus letters on the game board layout at a location and orientation responsive a location and orientation entered into the input device by said player and conveyed to the processor.

22. The gaming device of claim 15, said input device being configured as a touch screen for receiving inputs entered by the player.

23. The gaming device of claim 1, said processor being enabled to operate responsive to an input entered into an input device operated by the player and conveyed to the processor.

24. The gaming device of claim 23, said input device being configured to enable the processor responsive to receipt of a given input.

25. The gaming device of claim 23, said input device being configured to receive the given input in the form of one of a group consisting of a unique code identifying the player, a coin, a token, paper currency, a credit card, or a debit card.

26. The gaming device of claim 1, said processor being further configured to:
randomly generate from zero to N replacement letters and their associated values;
replace letters selected for discard with the replacement letters; and
display the replacement letters in a scrambled fashion together with letters not replaced and rearrange M of the N letters into another word, responsive to a discard request.

27. The gaming device of claim 26, said processor being further configured to:
randomly generate replacement letters and their associated values;
replace letters selected for discard;
display the replacement letters in a scrambled fashion together with letters not replaced; and
rearrange M of the N letters into still another word, responsive to another discard request.

28. The gaming device of claim 27 said processor being further configured to calculate said payout responsive to display of one of said word, said another word or said still another word.

29. The gaming device of claim 1, wherein the processor is configured to provide selection between at least two variants of an anagram.

30. The gaming device of claim 1, wherein the processor is configured perform the steps of claim 1 in accordance with the rules of SCRABBLE®.

31. A method for providing a game to a remote user through one of a wired and wireless communication, comprising:
randomly generating N letters responsive to receipt of a request to participate from the remote user (RU), said letters each having a given point value associated with each letter;
transferring the N letters to the RU for display in a scrambled manner;
rearranging the M letters to create a word containing M of the N letters by accessing a database containing a vocabulary having a given number of words where 1≧M≦N;
determining a total of the values of said M letters;
transferring the arranged letters and total to the RU for display; and
determining a payout based on said point count upon receipt of a given message from the RU.

32. The method of claim 31 wherein the RU is identified and authenticated responsive to a request to participate.

33. The method of claim 31 wherein creating the word further comprises creating the word having a highest point count.

34. The method of claim 31 further comprising:
sending an invitation to the RU to engage in a draw operation to discard from zero to N of said letters;
replacing each of said zero to N of said letters identified to be discarded by the RU with a randomly generated letter; and
transferring the replaced letters, if any, and their associated numeric values to the RU for display in a scrambled manner.

35. The method of claim 31 further comprising:
creating a word of N letters based on the letters currently held by the RU and the database vocabulary;
determining a total point count of the current word;
comparing the total point count of the word with the highest point word placed on the display after the draw operation to the highest point word created prior to the draw operation to determine that word having the highest point count for display; and
transferring that word having the highest point count to the RU for display.

36. The method of claim 35 wherein the word created before the draw operation and the word created after the draw operation is the same word.

37. The method of claim 35 further comprising calculating a payout based on the highest point count.

38. The method of claim 35 further comprising calculating a payout based on a payout table sent to the RU for display by the RU.

39. The method of claim 37 further comprising providing a payout to the RU responsive to a request for a payout from the RU.

40. The method of claim 31 further comprising:
sending a board game invitation to the RU to play a board game responsive to a given event;
creating and sending for display a board game layout responsive to an acceptance for the board game invitation from the RU;
sending N randomly generated bonus letters to the RU for display;
inviting the RU to provide a board position and an orientation for placing the bonus letters held by the RU on the game board layout;
placing the bonus letters on the game board layout at a location and orientation responsive to a request from the RU; and
sending for display the game board layout with the bonus letters placed on the game board layout at the location and orientation selected by the RU.

41. The method of claim 40 further comprising:
calculating and sending to the RU for display a bonus payout calculation based on the total point count of the bonus letters placed on the game board and any rewards on the game board layout to which the RU is entitled when at least one letter of RU's word is placed on a square of the game board layout having a reward.

42. The method of claim 41 further comprising:
inviting the RU to continue play; and
providing a payout to the RU responsive to a request by the RU to terminate play.

43. The method of claim 42 wherein the payout comprises a payout for the highest point value word and the bonus payout.

44. The method of claim 42 wherein providing a payout to the RU comprises:
entering the payout to an account maintained for the RU.

45. The method of claim 44 wherein the account is a credit card account.

46. The method of claim 40 further comprising:
inviting the RU to continue play;
randomly generating a second group of N letters having associated point values and sending them for display to the RU a scrambled manner;
creating a second word comprising M of the second group of letters, where 1≧M≦N and based on the database vocabulary; and
sending the second word of M letters for display to the RU.

47. The method of claim 31 further comprising:
sending a board game layout for display by the RU responsive to a given event;
sending, for display by the RU, N randomly generated bonus letters;
placing the bonus letters on the game board layout at a given location and orientation; and
sending for display by the RU the game board layout and bonus letters on the game board layout at a given location and orientation.

48. The method of claim 47 wherein said given event is a random event.

49. The method of claim 47 further comprising:
calculating and sending to the RU a bonus payout calculation based on the total point count of the bonus letters placed on the game board and any rewards on the game board layout to which the RU is entitled.

50. The method of claim 49 further comprising:
inviting the RU to continue play; and
providing a payout to the RU responsive to a request by the RU to terminate play.

51. The method of claim 47 wherein providing a payout to the RU comprises:
entering the payout to an account maintained for the RU.

52. The method of claim 51 wherein the account is a credit card account.

53. A method employed by a gaming device comprising a processor, a database containing a word list and a keyboard interfacing with the processor for use by a player, the method comprising:
the gaming device performing the steps of:
storing a requested number of games G_{R} entered by the keyboard;
accumulating a count G_{P} for each game played;
upon initiation of the first game:
presenting N randomly generated letters in a scrambled fashion on the display when G_{R}>G_{P}, each letter having a given point value;
presenting on the display a word of M letters retrieved from the database, where 1≧M≧N, said word having a highest point count;
performing a first draw operation responsive to operation of from zero to N HOLD keys and a draw button in the keyboard for retaining letters associated with the HOLD keys operated by the player and discarding all remaining letters;
randomly generating replacement letters, if any, for each discarded letter and displaying each replacement letter on the display at positions occupied by the discarded letter;
presenting on the display a common word of M letters retrieved from the database and which is either the first-mentioned word or another word, having a highest point count said common word being the common word for all games played;
performing a second draw operation responsive to selective operation of the HOLD keys and the DRAW key whereby letters associated the operated HOLD keys are retained and each remaining letter is replaced with a randomly generated replacement letter;
presenting on the display a word of M letters retrieved from the database utilizing the held letters and replacement letters remaining after the second draw operation, which word may be the first-mentioned word or another new word, said word having a highest point count; and
completing the first game by calculating a payout based on a payout table stored in a memory and a wager entered by the player;
initiating a second and subsequent games by incrementing the G_{P} count and placing the common word on the display including all letters not used to create the common word when G_{R} is greater than the present count of games;
performing a second draw operation for the second and subsequent games; and
completing a second and subsequent games by calculating a payout.

54. A method employed by a gaming device comprising a processor, a database containing a word list and a keyboard interfacing with the processor for use by a player, the method comprising:
the gaming device performing the steps of:
storing a number G_{R} representing a requested number of games responsive to a number entered via the keyboard;
keeping a count of the number G_{P} of games played;
randomly generating N letters and displaying the letters in a scrambled fashion on the display when G_{R}>G_{P};
searching the database, retrieving a word of M letters, where 1≧M≧N, said word having a highest point count and presenting the word on the display;
performing a first draw operation responsive to operation of a DRAW key in the keyboard by retaining letters selected to be retained by operating HOLD keys in said keyboard associated with the letters to be retained and discarding all remaining letters;
randomly generating a replacement letter for each discarded letter and displaying each replacement letter on the display at the positions occupied by the discarded letter;
searching the database, retrieving a word of M letters utilizing the held letters and replacement letters presently on the display and which may be the first-mentioned word or a new word, said word having a highest point count and presenting the word on the display;
performing a second draw operation responsive to operation of the DRAW key pressed by the player by retaining letters selected to be retained by the player by operating HOLD keys in said keyboard associated with the letters to be retained and discarding all remaining letters;
randomly generating a replacement letter for each discarded letter and displaying each replacement letter on the display at the positions occupied by the discarded letter;
searching the database, retrieving a word of M letters utilizing the held letters and replacement letters presently on the display, which word may be the first-mentioned word or another new word, said word having a highest point count, and presenting the word on the display;
completing the first game by calculating a payout based on a payout table stored in a memory and a wager entered by the player;
incrementing the games played count and replacing all of the letters on the display at the time of the payout with all of the letters on the display prior to initiation of the second draw operation G_{R} is greater than the present count of games played;
performing a second draw operation for the second and subsequent games; and
calculating a payout for second and subsequent games.

55. The method of claim 54 wherein keeping a count of the number of games played comprises;
clearing an accumulator, and incrementing the accumulator by one count preparatory to comparing a count in the accumulator with the number of games originally selected by the player.

56. The method of claim 54 wherein the processor further accesses the database to retrieve a definition of the word presented on the display.

57. A method for use by a gaming device to enable play of a plurality of games employing a processor, a database containing a wordlist and a keyboard respectively interfacing with the processor, comprising:
storing a number G_{R} of requested games entered in the keyboard;
keeping a count G_{P} of games played;
starting a first game by presenting N randomly generated letters on a display and rearranging the letters to form a word derived from the database to present a word having a highest point count;
initiating a draw operation by replacing from zero to N of the letters on the display with randomly generated letters responsive to operation of selected HOLD keys in the keyboard and generating highest point value word;
determining a highest point value of the word displayed after the draw operation;
completing the first game by calculating a payout, if any, based on a payout table visible to a player; and starting a second and subsequent games with the word and replacement letters, if any, on the display prior to the draw operation if G_{R}>G_{P}.
